(19) United States
(12) Patent Application Publication
(10) Pub. No.: US 2010/0138775 A1
(43) Pub. Date: Jun. 3, 2010

(54) METHOD, DEVICE AND SYSTEM, FOR EXTRACTING DYNAMIC CONTENT FROM A RUNNING COMPUTER APPLICATION

(76) Inventors: Sharon Kohen, Kfar Bilu (IL); Roland Mishaev, Kfar Saba (IL)

Correspondence Address: Pearl Cohen Zedek Latzer, LLP, 1500 Broadway, 12th Floor, New York, NY, 10036, US

(21) Appl. No.: 12/626,804

(22) Filed: Nov. 27, 2009

Related U.S. Application Data
(60) Provisional application No. 61/118,531, filed on Nov. 28, 2008.

(51) Int. Cl. G06F 9/46; G06F 3/048

(52) U.S. Cl. 715/781; 719/313; 715/856

(57) ABSTRACT

A system and computer implemented method is provided for monitoring dynamic application data. A request to monitor a sub-region within a display page of a user interface of a second application may be accepted in a first application. The first application may iteratively capture data during the operation of the second application. The first application may determine that an instance of the captured data matches data representing the requested sub-region or page and in response, may extract content associated with the requested sub-region from the captured data. The first or second application may display the extracted content, for example, for monitoring the requested sub-region of the second application.

### PRIOR APPLICATION DATA

The present application claims the benefit of prior U.S. provisional application Ser. No. 61/118,531, filed Nov. 28, 2008, and entitled “METHOD, SYSTEM AND SOFTWARE PRODUCT FOR RESOLVING RUNTIME INTERESTING INFORMATION FROM A RUNNING COMPUTER APPLICATION,” incorporated by reference herein in its entirety.

### FIELD OF THE INVENTION

The present invention relates to methods, devices, and systems for extracting and updating dynamic content from a running Application.

### BACKGROUND OF THE INVENTION

A user may wish to monitor a predefined set of target dynamic information in a running software application. The set of target dynamic information may be referred to as “interesting application information” (IAI). For example, an IAI element may include a ‘high score list’ in a game application. The list may be stored and updated internally in the game application and displayed on the player screen. However, some applications may not provide an application programming interface for accessing IAI for use in other applications, and may not store the IAI in a location accessible to other applications or at all. For example, some applications may not provide a mechanism for exporting a ‘high scores list’ and comparing it with high scores generated by other users of the application on other computer systems. In addition, some applications may not provide an application programming interface for accessing IAI for use in generating statistics or other information regarding a user's use of an application. In addition, applications desired to be monitored may come from different application developers and use different interfaces, formats and displays, including different formats and locations of IAI, that are not consistent across all applications.

Accordingly, there is a need in the art for an improved mechanism to monitor applications.

### BRIEF DESCRIPTION OF THE DRAWINGS

Specific embodiments of the present invention will be described with reference to the following drawings, wherein:

FIG. 1 is a schematic illustration of a system for extracting and monitoring dynamic target information in a running application in accordance with an embodiment of the invention;

FIG. 2 is a schematic illustration of an application running on a user computer of the system 100 of FIG. 1 in accordance with an embodiment of the invention;

FIGS. 3A and 3B are schematic illustrations of a user interface of the application of FIG. 2 in accordance with embodiments of the invention;

FIG. 3C is a schematic illustration of an application monitoring interface for monitoring the application of FIG. 2 in accordance with an embodiment of the invention;

FIG. 4 is a schematic illustration of a modeling method for monitoring the application of FIG. 2 in accordance with an embodiment of the invention;

FIG. 5 is a schematic illustration of a method for monitoring the application of FIG. 2 during application runtime in accordance with an embodiment of the invention;

FIG. 6 is a schematic block diagram of a user computer system in accordance with an example embodiment;

FIG. 7 is a schematic block diagram of a server computer system in accordance with an example embodiment;

FIG. 8 is a schematic block diagram of multiple users connected to multiple servers in accordance with an example embodiment; and

FIG. 9 is a schematic of process and information flow between a client side and a server side computing system in accordance with an example embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

In an embodiment of the invention, dynamic application data may be monitored. A request to monitor a sub-region within a display page of a user interface of a second application may be accepted in a first application. The first application may iteratively capture data during the operation of the second application. The first application may determine that an instance of the captured data matches data representing the requested sub-region or page and in response, may extract content associated with the requested sub-region from the captured data. The first or second application may display the extracted content, for example, for monitoring the requested sub-region of the second application.

In an embodiment of the invention, dynamic application data may be monitored. An application having a user interface with multiple display pages may be run. A request to monitor a sub-region within one of the display pages of the application may be received. Data from the application user interface may be iteratively captured. In response to determining that the captured data matches data that represents the requested one of the display pages, content associated with the requested sub-region may be extracted from the captured data. The extracted data may be displayed.

In an embodiment of the invention, conditions for monitoring dynamic data in an application may be generated. Data may be accepted identifying a sub-region within a display page of the application. The sub-region may include the dynamic application data. One or more criteria may be accepted to iteratively trigger data to be captured from a user interface of the application. Data representing the sub-region, e.g., metadata, may be generated for comparing to the captured data. A trigger may be generated to extract content from the captured data associated with the requested sub-region when the data representing the sub-region matches the captured data or data representing the captured data. The trigger to extract content from the captured data may be stored, e.g., in a memory unit.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

When used herein, interesting application information (IAI) may refer a set of dynamic target information that is a subset of a larger set of running application data. Dynamic target information may be extracted from screen shots, back buffers, duplicate data, or discarded data of a running application so to not use or disrupt the in-process data being used by the application itself. The application being monitored and the monitoring application or module may be separate applications or modules run simultaneously, in parallel, or concurrently, each acting on a separate set of data.

Embodiments of the invention include a system and method for dynamically extracting and updating a set of dynamic target information embedded in a running application. The set of dynamic target information may be automatically rendered, e.g., in real-time, to the user of the application or to a remote viewer. The set of dynamic target information may include, e.g., as a whole or by any combination thereof, the following information:

Information indicating one or more modules or parts of the application that are running and/or the flow of control and operations that use these modules or parts.

Information indicating the outcomes of user operations in the application.

Information indicating one or more value(s) (e.g., numbers, text fields, icons, etc.) displayed to a user on an application user interface (UI).

Information indicating user input (e.g., keystrokes, button clicks, features used, etc.), e.g., using a known Input/Output (I/O) mechanism.

It may be appreciated that other target information may be extracted from an application during runtime and the previous list includes only a few such examples.

The set of dynamic target information indicating value(s) displayed to a user on an application monitoring user interface (UI) may include, for example, a text, numeric, or graphical object, such as a still icon or picture or a moving image displayed on a user display or screen. In one embodiment, the set of dynamic target information may include some or all data in a specific coordinate region of a user display. For example, a user may enter coordinate values or select a region or objects on a screen to be monitored, e.g., by clicking, drawing, highlighting, or dragging with a mouse. In another embodiment, the set of dynamic target information may include a type of data, such as a high score list, which may be indicated by a user or programmer and automatically found on a screen and monitored. In some embodiments, the set of dynamic target information may include data that moves to different coordinate locations within a page or screen during application runtime. For example, in a gaming application, player statistics may be display in a moving display field so as not to obstruct other moving objects within the game. In one embodiment, the target information may be identified by a non-location feature, e.g., a color, contrast setting, design, etc. In another embodiment, the initial location of the moving target information may be identified, e.g., by a user or automatically by a processor, and logic may be implemented not only to update the dynamic content of the target information, but also to track the dynamic location of the target information. In another example, when a game application includes multiple pages, e.g., representing different scenes or states of the game application, the dynamic target information may have different locations in some or all of the multiple pages. In one embodiment, the dynamic target information may be identified by a location as well as a page on which the information is displayed in that location. The same type of dynamic target information, e.g., high score list, may be identified by multiple data sets representing the different displays of the same dynamic target information on different pages in a multiple page application. Other types and uses of dynamic target information may be used.

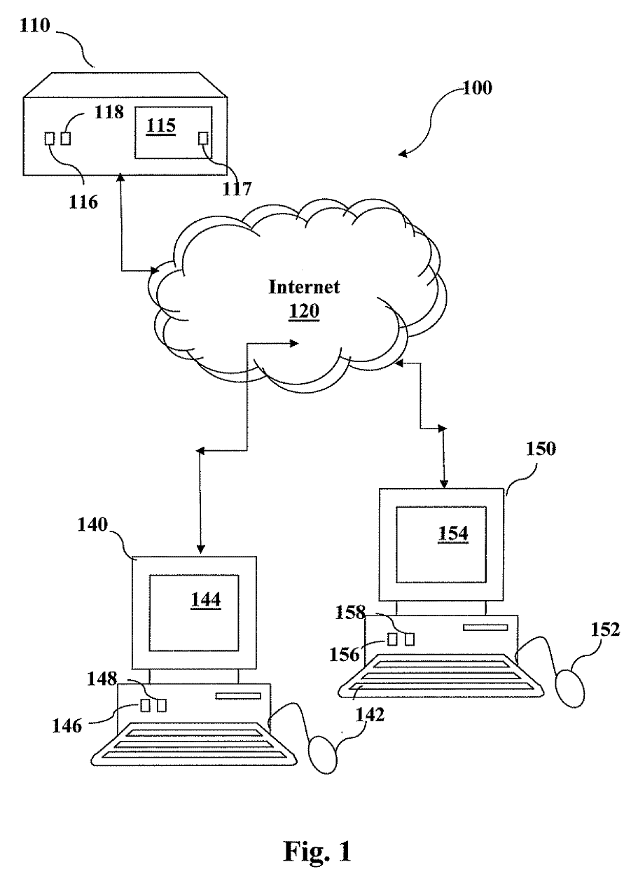

Reference is made to FIG. 1, which schematically illustrates a system 100 for extracting and monitoring dynamic target information in a running application in accordance with an embodiment of the invention. System 100 may include a server 110 for communicating with an associated database 115, one or more user computer(s) 140, and one or more client or programmer monitoring computer(s) 150, all of which are connected via a network 120 such as the Internet.

Server 110 may include applications for retrieving and viewing dynamic content on user computer 140. For example, server 110 may include applications capable of generating code or plug-ins in a programming language compatible with incorporation in certain application or websites, such as, for example, in JavaScript. Server 110 may remotely store and analyze dynamic target information running on user computer 140 or may provide user computer(s) 140 or monitoring computer(s) 150 with logic modules to locally analyze and monitor the dynamic data running on user computer 140. Server 110 may include applications for interacting with user computer 140 and monitoring computer 150.

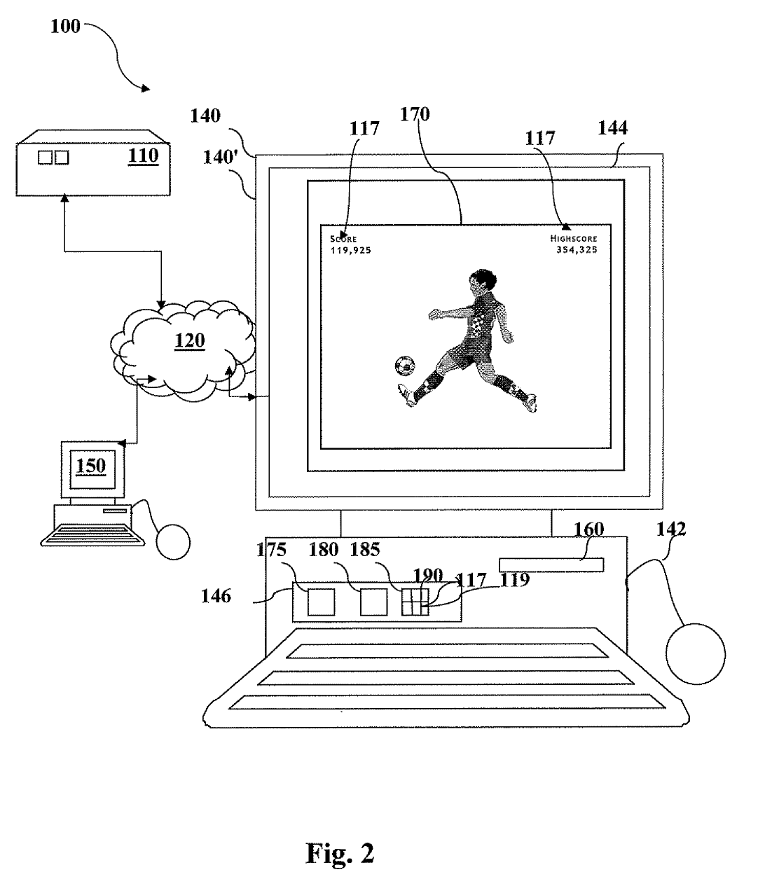

Database 115 may include software processes or applications for extracting dynamic target information 117 for monitoring applications on user computer 140. Database 115 may store data associated with each application process, run-time session, user, etc., and may include statistical data relating to a usage history for each set of target information 117. Database 115 may store code (e.g., software code 180 of FIG. 2) for monitoring dynamic target information 117 and logic (e.g., page detection anchors 119 of FIG. 2) for capturing data from a running application and extracting dynamic target information 117 therefrom. An anchor may be defined as a specific pre-selected image object within an application page, which is visibly stable while the page is displayed. A page may be detected by identifying the presence of the specific pre-selected image object, e.g., even when the page content changes or shifts, but the specific pre-selected image object is still visibly stable and unchanged. The code may include, e.g., logic to track a dynamic location of a moving set of dynamic target information 117 or to enable display features of dynamic target information 117 on user computer 140 and/or monitoring computer 150. Database 115 may be internal or external to server 110 and may be connected thereto by a local or remote and a wired or wireless connection. In alternate embodiments, dynamic target information 117 may be stored in an alternate remote location separate from database 115, e.g., memory unit(s) 118 or locally on user computer 140 and/or monitoring computer 150.

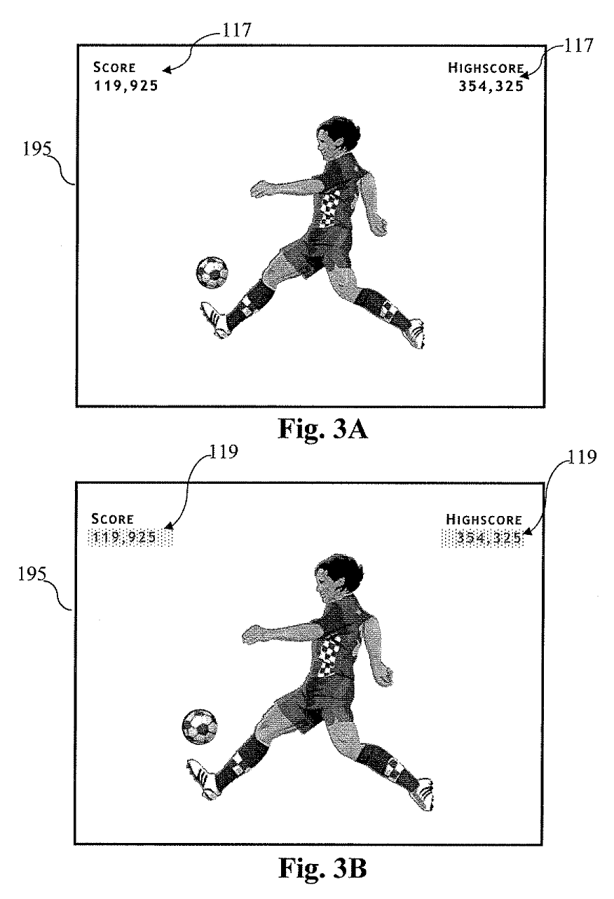

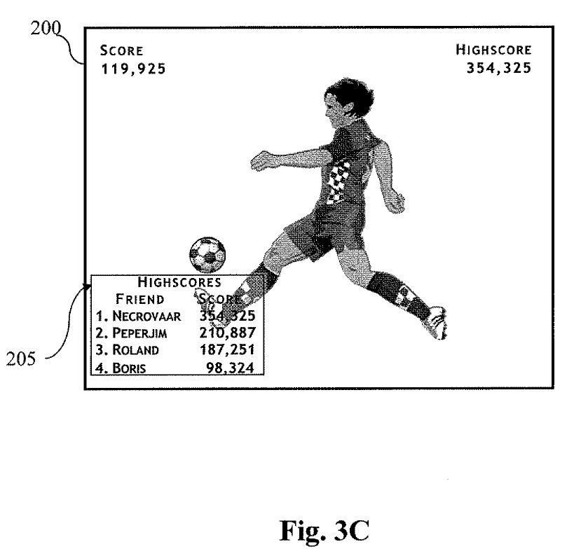

One or more monitoring computer(s) 150 may remotely view dynamic target information 117 running on user computer 140. Monitoring computer 150 may design or select the desired set of dynamic target information 117 to be monitored and may design or select an application monitoring interface 200 for displaying the extracted dynamic target information 117, e.g., as shown in FIG. 3C. Monitoring computer 150 may be operated by programmers to monitor user computer 140, e.g., for error detection, fraud detection, or quality assurance or by other remote user of the same application running on user computer 140, e.g., competing in an interactive multi-player game or editing a shared on-line document.

User computer 140 and monitoring computer 150 may be personal computers, desktop computers, mobile computers, laptop computers, and notebook computers or any other suitable device such as a cellular telephone, personal digital assistant (PDA), video game console, etc., and may include wired or wireless connections or modems. User computer 140 and monitoring computer 150 may include one or more input devices 142 and 152, respectively, for receiving input from a user (e.g., via a pointing device, click-wheel or mouse, keys, touch screen, recorder/microphone, other input components). User computer 140 may include one or more output devices 144 (e.g., a monitor or screen) for displaying running application data having dynamic target information embedded therein. Monitoring computer 150 may include one or more output devices 154 for remotely monitoring dynamic target information 117.

Network 120, which connects server 110, user computer 140 and advertiser computer 150, may be any publicly accessible network such as the Internet. Access to network 120 may be through wire line, terrestrial wireless, satellite or other systems well known in the art.

Server 110, user computer 140, and monitoring computer 150, may include one or more controller(s) or processor(s) 116, 146, and 156, respectively, for running applications and one or more memory unit(s) 118, 148, and 158, respectively, for storing data (e.g., dynamic target information 117) and/or instructions (e.g., software) executable by a processor. Processor(s) 116, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 148, and/or 158 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units. Memory unit 148 may include a capture buffer, e.g., capture buffer 185 as shown in FIG. 2.

Reference is made to FIG. 2, which schematically illustrates an application 170 running on a user computer of the system 100 of FIG. 1 in accordance with an embodiment of the invention. User computer 140 may operate processor(s) 146 to load application 170 from memory 148 or from a web site transmitted over network 120. Application 170 may include code 175 for operating application content. A separate monitoring application or module 160 may be used to monitor application 170. Monitoring module 160 may include code 180 for extracting target dynamic information 117 from application 170. Code 180 may be loaded (e.g., from server 110) in a programming language compatible with application code 175. Code 175 and code 180 may be stored in memory unit(s) 148, for example, at least temporarily while user computer 140 operates application 170. Code 180 may include page detection anchors 119 corresponding to each element of target dynamic information 117. Page detection anchors 119 may include logic for extracting the corresponding target dynamic information 117 element(s) from a running application 170, e.g., by cropping a region of the application 170 screen shot or a back buffer defined by the page detection anchor 119 to generate an anchor image. Page detection anchors 119 and target dynamic information 117 may be stored as metadata 190 in a capture buffer 185 on user computer 140.

Processor(s) 146 may operate application 170 to run on user computer 140 and to invoke code 180, which in turn extracts target dynamic information 117 from application 170. Target dynamic information 117 may be stored locally on user computer 140 and/or remotely on server 110 and/or monitoring computer 150. Target dynamic information 117 may be stored with associated identification information, such as, page detection anchors 119. Page detection anchors 119 and/or target dynamic information 117 may include coordinate location, color, contrast, or other geometric, textural or graphical feature of the target content (e.g., viewed on user interface 195 or FIGS. 3A and 3B). Page detection anchors 119 and/or target dynamic information 117 may include, descriptive information that describes the target information content or usage history, a user, session or application ID, a list of targeted keywords or values, on which of multiple pages the target content appears when a multi-page application is used, or other identifiers, metadata 190, and/or content from application 170.

Reference is made to FIGS. 3A and 3B, which schematically illustrate a user interface 195 of application 170 on user computer 140 of FIG. 2 in accordance with an embodiment of the invention. User interface 195 may include dynamic target information 117 (e.g., a high score). Processor(s) 146 may extract dynamic target information 117 using resources of the running application 170, e.g., application metadata 190, which do not affect the operation of application 170 data itself. Processor(s) 146 may extract application metadata 190 using a screen shot of user interface 195 or by copying a screen shot buffer from user computer 140. Dynamic target information 117 may have a corresponding set of page detection anchors 119, which may be the logic for extracting each dynamic target information 117 element.

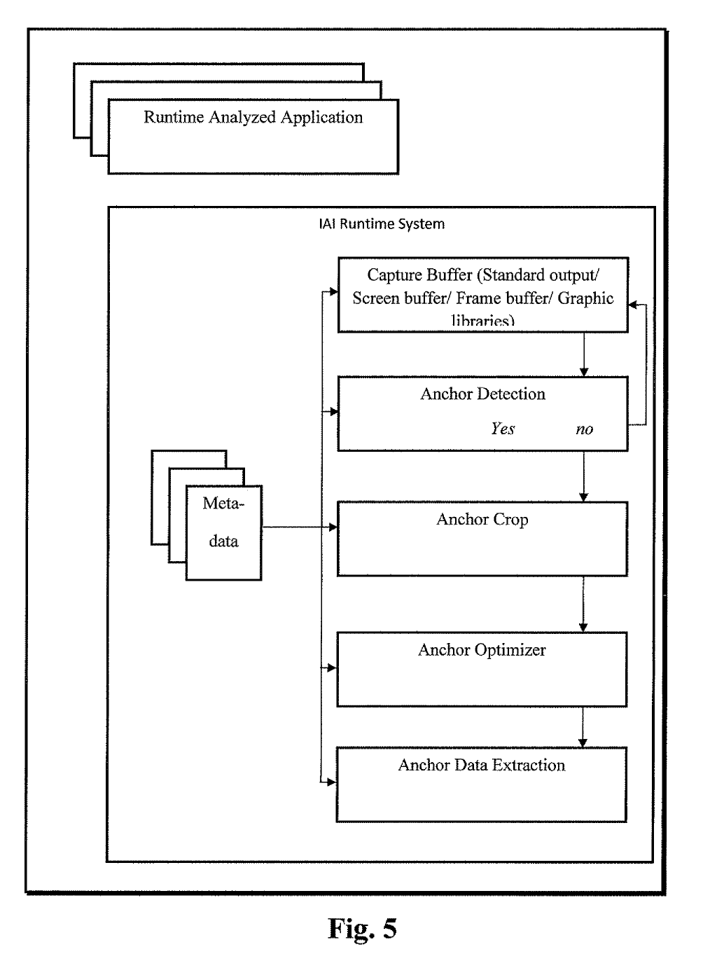

According to embodiments of the invention embodiments, a separate monitoring application or module 160 may be implemented independently of application 170 to monitor dynamic target information 117 of application 170 displayed on user interface 195. In one embodiment, a modeler may request to monitor one or more target sub-regions within one or more target display pages of user interface 195 of application 170. For example, the modeler may draw a target sub-region such as a rectangle with a pointing device on user interface 195 and set the sub-region as dynamic target information 117. Monitoring module 160 may implement a capture mode during the runtime of application 170, in which content may be iteratively captured from user interface 195 of application 170. Monitoring module 160 may capture screen shots of user interface 195 or copy back buffers of a screen device (e.g., user display 144). In one embodiment, the entire screen shot is captured iteratively. In another embodiment, only a portion of the screen shot, e.g., the target sub-region, may be captured iteratively. Each iteration of screen capture may be triggered by an event, e.g., the lapse of a predetermined time interval or upon an event of action in application 170 such as receiving predetermined user input known to affect dynamic target information 117. For example, when a user shoots a weapon known to affect the score in a game and dynamic target information 117 is a user score sub-region, a user clicking or selecting designated shooting keys of an input device may trigger a screen capture. Application 170 may have multiple pages, some of which include the sub-region dynamic target information 117 and some of which do not. To determine whether or not to extract content from the captured screen shots of user interface 195, monitoring module 160 may determine whether or not the captured content are the target display pages and/or target sub-regions to be monitored. The captured content and the target pages and/or sub-regions selected by the modeler may include metadata 190. Monitoring module 160 may capture the entire page or sub-regions iteratively content and then compare metadata 190 of the captured content with metadata 190 of dynamic target information 117. If the respective metadata 190 substantially match, it may be determined that the content was captured from the target page or of the target sub-regions and therefore, data should be extracted from the captured content. Monitoring module 160 may execute page detection anchor 119 logic to further extract information from the captured content to generate dynamic target information 117 that may be displayed to a user for monitoring application 170, e.g., as described in further detail in reference to FIG. 5. If the respective metadata 190 of the captured content and dynamic target information 117 do not match, it may be determined that the captured content does not contain dynamic target information 117 and no data is extracted from the captured content.

Reference is made to FIG. 3C, which schematically illustrates an application monitoring interface 200 for monitoring application 170 in accordance with an embodiment of the invention. Application monitoring interface 200 may include a dynamic information display field 205 for displaying dynamic target information 117. A new set of dynamic target information 117 may be iteratively updated in dynamic information display field 205, for example, periodically or each time new content is extracted from captured data. Application monitoring interface 200 may be displayed on monitoring computer 150 for remotely monitoring application 170 usage in user computer 140 and/or directly on user computer 140 for the application user to locally monitor their own, e.g., and optionally other user's usage of application 170. When a user monitors their own application activity, user interface 195 may be application monitoring interface 200 and dynamic information display field 205 may be displayed thereon.

In a demonstrative embodiment, an application 170 running a video game session on user computer 140 may be monitored by retrieving dynamic target information 117 indicating user achievements in the game, e.g., high scores, averages, or other statistics related to the user performance during the gaming session. Game applications generally do not support this functionality. Conventional monitoring systems typically add such functionality, e.g., to a video game, by altering the software itself. Such systems may result in the video game code being potentially harmed and may also require that the application be redistributed and/or reinstalled.

According to embodiments of the invention, additional functionality may be implemented independently of the operation of application 170, e.g., in a separate monitoring application of module 160. During runtime of application 170, separate modeling module 160 may extract dynamic target information 117 from data not used by application 170 (e.g., “out-of-process” data) so as not to affect the operation of application 170. The out-of-process data may include screen shots of user interface 195, copied back buffers, duplicate data, or data discarded by application 170.

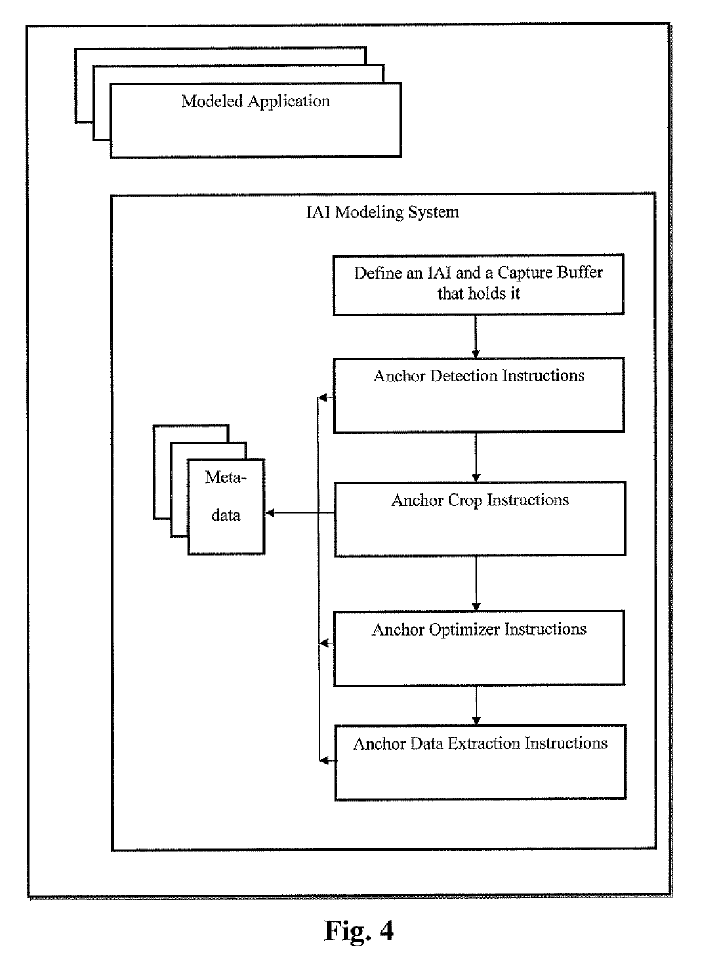

According to embodiments of the invention, mechanisms for monitoring an application may be executed in a modeling phase (described in reference to FIG. 4) and a runtime phase (described in reference to FIG. 5). Although the modeling phase and a runtime phase are described separately, these phases or any operations therein may be used in combination.

### Modeling Phase

Reference is made to FIG. 4, which schematically illustrates a modeling method for monitoring application 170 in accordance with an embodiment of the invention. A modeling phase may be used for selecting dynamic target information 117 to be recognized and/or extracted from an application 170 (e.g., during a separate or concurrent runtime phase). For example, dynamic target information 117 selected for recognition in a game application 170 may include, e.g., a high score text element. The modeling phase may also include invoking code 180 to implement logic for executing such extractions. For example, the logic for extraction a ‘high score’ dynamic target information 117 from a game application 170 may include a specific pixel coordinate location in a screen shot of application 170 in which the high score dynamic target information 117 is listed and possibly a frequency for extracting an updated high score from this coordinate location. In another embodiment, for example, where the high score display location may change within a single page or between different pages of application 170, the logic for extraction may include logic to detect the dynamic location or logic to detect a non-location feature such as a specific color or color range in which the high score is known to be highlighted.

A modeling phase process may proceed, for example, to execute the following stages or operations.

Dynamic target information 117 may be selected by a modeler, e.g., a user or programmer. The modeler may use a modeling computer 140′ to run application 170 in the same manner as an ordinary user operating user computer 140. Modeling computer 140′ may have the same physical components and capabilities as user computer 140, but may be a different machine. Monitoring computer 140′ may include a simulation of running application 170, e.g., implemented offline from the runtime phase. Modeling, e.g., generating dynamic target information 117 to be extracted and the logic for extracting, may be programmed independently for each application 170 to be analyzed. The output of the modeling phase may include a set of metadata 190. Metadata 190 may include a set of dynamic target information 117 and a corresponding set of page detection anchors 119 (e.g., the logic for extracting dynamic target information 117). Metadata 190 may be the input for the runtime phase described in reference to FIG. 5. Metadata 190 may be implemented in a programming language compatible with extraction code 180 and/or application code 175, for example, binary, XML or some other form of database. The modeler may examine application 170 and define a set of metadata 190, e.g., including dynamic target information 117 and page detection anchors 119. In one embodiment, a modeler may select a sub-region of user interface 195 and processor 146 may automatically generate the dynamic target information 117 and page detection anchor 119 metadata 190 corresponding thereto.

Processor 146 may generate code 180 based on the modeler selection, which when run by processor 146 together with application code 175, may implement monitoring module 160 to extract dynamic target information 117 from application 170.

Code 180 instructions for each element of dynamic target information 117 may include, for example, the following:

Dynamic target information 117 identification. The modeler may define or select the information elements to be extracted from application 170, e.g., during an application simulation modeling phase. For example, the modeler may enter coordinate values or select, e.g., by clicking, drawing, or highlighting with a mouse, a region or objects on user interface 195 defining dynamic target information 117 to be monitored. In another embodiment, dynamic target information 117 may be identified by a visual or graphic feature, e.g., a color, texture, pattern, contrast setting, design, etc. A corresponding page detection anchor 119 may be generated for each element of dynamic target information 117. The modeler may also set a frequency, time interval, or trigger for iteratively capturing content from a running application 170. Otherwise, content may be captured at a default frequency.

Code 180 instructions for each page detection anchor 119 may include, for example, anchor detection instructions, anchors crop instructions, anchor optimizer instructions, and/or anchor data extractor instructions, which may be described, for example, as follows.

Anchor detection instructions: The modeler may define a page detection anchor 119, e.g., logic for extracting corresponding dynamic target information 117 from a running application 170. Each capture buffer 185 may, or may not, store one or more page detection anchors 119. Page detection anchor 119 may be a “piece” of capture buffer 185 to store content captured from application 170. Each page detection anchor 119 may be run through data extraction instructions (see below) to extract corresponding dynamic target information 117 from the captured content of running application 170. Each page detection anchor 119 may define structures/patterns to be matched or detected in capture buffer 185 to identify the existence of the target structures/patterns in the captured content. The modeler may examine application 170 output in the form of capture buffer 185 that holds page detection anchor 119. The modeler may then identify a set of structures/patterns to match in capture buffer 185 to determine if the set of structures/patterns of the captured content matches the set of structures/patterns of page detection anchor 119. Code 180 instructions may include machine code, raw data, images, etc. Each page detection anchor 119 detection instruction applied in the modeling phase may be executed during runtime phase operations, for example, including data transformations, contrast comparison, edge detection, etc. An example of page detection anchor 119 detection instruction may include processor 146 detecting data associated with a certain color and a certain coordinate location (x, y) in capture buffer 185. If such a detection is made, processor 146 may determine that capture buffer 185 holds a corresponding dynamic target information 117 element, e.g., a ‘high score’ element.

Anchors crop instructions: The modeler may select screen locations of target sub-regions where the dynamic target information 117 elements are displayed when running application 170, e.g., by defining coordinate(s) or region(s) of a display screen or window, e.g., of application user interface 195. The screen locations for dynamic target information 117 elements may correspond to capture buffer 185 locations, e.g., defined by a transformation having a one-to-one correspondence. Dynamic target information 117 elements may be cropped and stored in their corresponding capture buffer 185 locations. For a ‘high score’ element, for example, the modeler may define a part of application user interface 195 where the list is displayed (e.g., by entering a coordinate range or by highlighting a region of application user interface 195 with a mouse cursor). Metadata 190 may include a translation for each dynamic target information 117 indicating the coordinates (e.g., x, y, height and width) of each corresponding application user interface 195 location and capture buffer 185 location and/or a unique identification (ID) therefore.

Anchor optimizer instructions: The modeler may select, e.g., from a set of instructions, an optimization instruction to be applied to an anchor image, which may be generated during the runtime phase. The optimization instruction may trigger a specified optimization module, e.g., bit reduction or “Canny” edge detection modules, to be applied to the anchor image to prepare the image for data extraction. For example, if the contrast between dynamic target information 117, e.g., a text field, and the anchor image background is below a predetermined threshold or determined by the modeler to be sub-optimal, the modeler may execute a contrast change transformation function on the anchor image. In one embodiment, a null-transformation or no transformation may be applied to the anchor image if no optimization is desired.

Anchor data extractor instructions: The modeler may select one or more extraction modules or functionalities, e.g., from a set of options provided to the modeler. The modules may include optical character recognition (OCR) modules, image recognition modules, pattern recognition modules, or other modules that input page detection anchor 119 data and output corresponding dynamic target information 117 element(s). A value or ID of each dynamic target information 117 element may be displayed to a user, e.g., on a user interface of monitoring module 160. The selected extraction module(s) may be applied to the optimized anchor image in order to extract the information displayed therein during the runtime phase. For example, for page detection anchor 119 to extract a ‘high score’ dynamic target information 117 described above, the modeler may define a single-line OCR engine for content extraction.

The above instructions may provide, for each application 170, a group of page detection anchors 119 to be stored as metadata 190 for m monitoring module 160 to extract corresponding dynamic target information 117. Metadata 190, e.g., including, dynamic target information 117 and page detection anchors 119 may be set as input for the runtime phase described in reference to FIG. 5.

Other code 180 instructions, page detector anchors 119, operations or order of operations may be used in the modeling phase to improve accuracy, enhance performance, and scale up system 100.

### Runtime Phase

Reference is made to FIG. 5, which schematically illustrates a method for monitoring a running application 170 in accordance with an embodiment of the invention. The runtime phase may include running application 170 on user computer 140 and monitoring the application (e.g., the same application analyzed in the modeling phase). During the runtime phase, monitoring module 160 iteratively captures screen shots of the running application 170 from user interface 195. Processor 146 may store the captured data in captured buffer 185 for analysis. Some iterations of captured data may not include dynamic target information 117 or the target sub-region, e.g., when application 170 includes multiple pages or windows and some pages do not display dynamic target information 117. In other iterations of captured data, the presence or exact location of dynamic target information 117 may be unknown, e.g., when dynamic target information 117 is a moving graphical object within one page or when dynamic target information 117 is displayed in different locations on different respective pages. In these cases, monitoring module 160 may determine if the captured content for each iterative capture contains dynamic target information 117. In one embodiment, monitoring module 160 may compare the respective metadata 190 of the captured content and dynamic target information 117 and if they match, it may be determined that the captured content contains dynamic target information 117.

Dynamic target information 117 may be extracted from the captured data and monitored during the runtime phase according to the data and functionality selected during the modeling phase.

An application 170 process may be executed using application code 175 and application memory resources within the operating system. A user may interact with an application 170 process, e.g., using input device 142, and processor 146 may render the user input information on an output user interface 195 or monitoring user interface 200 of output device 144 or 154.

The output of application 170 process may be displayed using a graphic user interface mechanism, such as standard output, screen buffer, frame buffer, graphic libraries (e.g., DirectX), etc.

Processor 146 may execute code 180 instructions of monitoring module 160 together with application code 175 instructions of application 170 in the runtime phase to extract dynamic target information 117 from application 170 for monitoring the application. A runtime phase process may proceed, for example, to execute the following stages or operations.

Capture buffer: An access module may capture content from application 170 user interface 195 and store the captured content in a designated corresponding location in capture buffer 185. Sampling may be executed by a mechanism known in the art, for example, including screen capturing or copying a back-buffer of a screen device. In one embodiment, the captured content may be taken of the full content displayed on user interface 195 or output device 144, e.g., as a whole or in pieces. Alternatively, the captured content may be selectively taken, e.g., at the target sub-region where dynamic target information 117 element is located. Sampling may be repeated periodically to update the captured content. Sampling content may be repeated periodically, e.g., at a regular predefined frequency, e.g., a default value or defined by a modeler during the modeling phase. Alternatively, content may be sampled at irregular times, e.g., in response to a user activity. For example, content may be sampled each time user triggers an input likely to affect the values, for example, when a player in a game application uses a weapon.

Anchor detection: Processor 146 may run a detection mechanism to determine if captured data includes dynamic target information 117. For example, monitoring mechanism 160 may search capture buffer 185 for specific structures/patterns of the captured content matching those defined by page detection anchors 119. Each specific structure/pattern defined by one or more page detection anchors 119 may correspond to specific dynamic target information 117. The correspondence may be set in the modeling phase. For example, a region of bits sequence (e.g., indicating yellow color) in capture buffer 185 may indicate a new high score is displayed in the captured content of a game application screen. Processor 146 may detect a pattern in capture buffer 185, for example, when data indicating a certain color in a certain location (x, y) is found in capture buffer 185. Such detection may indicate that capture buffer 185 stores the dynamic target information 117, e.g., a ‘high score,’ corresponding to the detected structure/pattern, e.g., color and location (x,y) in two-dimensions (2D) or (x,y,z) in three-dimensions (3D). Processor 146 may detect structures or patterns in capture buffer 185, using methods known in the art. Metadata 190 may include or correspond to a list of page detection anchors 119, each with specific logic and structures/patterns for detection, e.g., as defined in the modeling phase. The complexity for naïve pattern detection may be O(n).

Anchor cropping: If the detection mechanism detects a specific structure/pattern in capture buffer 185 that matches the list of page detection anchors 119, it may be determined that the captured content contains dynamic target information 117. In some embodiments, for example, when a full screen shot or a screen shot sub-region larger than the target sub-region is captured, the target sub-region may be cropped from the captured content as an anchor image. For example, a part of the captured content store in capture buffer 185 may be cropped, e.g., according to the page detection anchor 119 metadata 190 defined in the modeling phase. In the above ‘high score’ example, the part of the captured content that stores the ‘high score’ dynamic target information 117 may be a piece of capture buffer 185 containing an image, e.g., having a size of 300 pixels (in width) by 250 pixels (in height) starting from point having coordinates of 100 (along an x-axis) by 150 (along a y-axis) in capture buffer 185. This part of capture buffer 185 may be cropped and stored as a separate anchor image. In another embodiment, capture buffer 185 may store an indicator or pointer to the anchor images, but not the images themselves. The complexity of these operations is, for example, O(1).

Anchor optimizer: Metadata 190 generated during the modeling phase may define, for each corresponding page detection anchor 119, a function, filter or optimization mechanism to apply to the anchor image to prepare the anchor image for data extraction. Examples of such functions may include, for example, contrast change, color filtering, resizing, and bit-reduction. The resulting image may be an optimized anchor image. When no optimization is desired, a null or no optimization mechanism may be used.

Anchor data extraction: Page detection anchor 119 metadata 190, e.g., defined in the modeling phase, may be applied to each anchor image resulted from the anchor cropping or anchor optimizer step to extract the corresponding dynamic target information 117 element(s). Extraction mechanisms may include, for example, pattern recognition and OCR. For example, for a ‘high score’ page detection anchor 119, processor 146 may apply an OCR mechanism to identify characters embedded in an anchor image and extract the characters in the form of a textual string holding the ‘high score’, e.g., as shown in dynamic information display field 205 of application monitoring interface 200 of FIG. 3C. Complexity for naïve pattern recognition may be O(1).

Dynamic target information 117 display: The extracted dynamic target information 117 element(s) may be displayed on dynamic information display field 205 of application monitoring interface 200, e.g., as shown in FIG. 3C. The dynamic target information 117 may be displayed and monitored, e.g., locally on the user computer 140 running application 170 or remotely at a separate monitoring computer 150.

Other operations or order of operation may be used in the runtime phase to improve accuracy, enhance performance, and scale up system 100.

Embodiments of the invention may provide a device, system, and method for monitoring a running application 170 by extracting dynamic target information 117 from application 170 during runtime. Embodiments of the invention may include software and hardware designed to emulate a user perception of an application user interface. The software and hardware may, for example, detect application 170 rendered screens, resolve parts of displayed application 170 data and/or compile application 170 information, e.g., defined during the modeling phase.

Embodiments of the invention may provide benefits over conventional mechanisms that include, for example, the following.

A generic approach independent of the nature of application 170: In contrast to conventional mechanisms, which are typically tailored specifically to the framework and infrastructure of the application to be monitored, embodiments of the invention may be implemented, e.g., in the screen render level, in a separate monitoring application or module 160 that adds functionality independently and outside of application 170.

Non-intrusive to application 170 processes: A concern for extracting dynamic target information 117 includes negatively impacting the operation or efficiency of the running application 170. Embodiments of the invention include, monitoring the application 170 data in a separate monitoring module 160 using separate data that may operate in parallel to application 170. In this way, the monitoring module 160 typically does not impact the efficiency of application 170 processes, e.g., avoiding hang-ups or crashes when content is captured or dynamic target information 117 is extracted from application 170. Monitoring module 160 may be used to monitor application 170 that does not affect the memory or execution steps of application 170 by operating on the application 170 metadata 190 and not on the application 170 data itself (e.g., data in the application 170 processor pipeline).

Flexible architecture: Embodiments of the invention may be incorporated in a variety of architectures. Monitoring applications may be implemented as independent processes, in a distributed system, or incorporated into other systems and methods. In one embodiment, monitoring module 160 for extracting dynamic target information 117 may reside on the same machine as the application 170 to be monitored, while the logic for extracting dynamic target information 117 may be reside separately (e.g., in a remote server 110) from the logic for running application 170. In another embodiment, dynamic target information 117 may be stored separately from the logic for running the application 170 (e.g., in a remote server 110, which may be designated for storing dynamic target information 117).

Dynamic solution: Dynamic target information 117 usage may be expanded and the logic enhanced. The logic and the information to be observed and analyzed may be modeled as metadata 190. Metadata 190 including dynamic target information 117 and the logic for analyzing and extracting dynamic target information 117 (e.g., page detection anchors 119) may be altered independently of data within application 170 (e.g., data in the application 170 processor pipeline). Multiple distinct sets of metadata 190 may be used to monitor different properties of the same application 170. The multiple sets of metadata 190 may be analyzed independently or concurrently, e.g., for simultaneously monitoring different properties of the running application 170. For example, in an application user interface 195 shown in FIGS. 3A and 3B (e.g., in a game application), a first set of metadata 190 may be used to monitor a first dynamic target information 117 element of the application user interface (e.g., a high score field) and a second set of metadata 190 may be used to monitor a second dynamic target information 117 element of the application user interface (e.g., a current score for a game session). Other sets of metadata 190 may be used to monitor other dynamic target information 117, e.g., statistics related to the high score, an average of past and current scores, an improvement rating, a ranking, etc. These metadata 190 and dynamic target information 117 may be selected, e.g., in the modeling phase.

Simple operations: The dynamic target information 117 may be selected by a modeler using knowledge of application 170 operations and the modeling mechanisms, described herein.

Embodiments of the invention may be used to monitor dynamic target information 117 in an application 170 for unlimited purposes. Purposes or functionality of mechanisms executed according to embodiments of the invention may include, for example, the following.

Added value to application: Dynamic target information 117 may be utilized to introduce features not available in the application 170 itself. For example, dynamic target information 117 may be extracted from a word processor application 170 to improve user typing skills, even if the functionality is not part of the word processing application 170.

Usability testing: Application 170 developers or other parties may use dynamic target information 117 to learn how users are interacting with application 170. Metrics, such as error message counts, may be compiled from one or many user session(s). Information from the metrics may indicate, e.g., to developers, pitfalls in application 170 design, e.g., indicating that a section in an application user interface may be too complicated for the users and should be redesigned.

Support assistance: Based on a predefined set of observations, dynamic target information 117 may be generated regarding problems a user is facing. Support personnel, or an automated tool, may use dynamic target information 117 in its raw form, or after being processed, to offer the user appropriate solution.

Quality assurance: Dynamic target information 117 may be used in the process of quality assurance to check for the correct behavior of the software. For example, by operating the application in a predefined way the application is expected to produce expected dynamic target information 117. Differences between the expected dynamic target information 117 and the resulting dynamic target information 117 may indicate an application 170 bug.

Feature Usage Monitoring: A service provider or software publisher may use dynamic target information 117 to monitor user activities in application 170. This may be used, for example, for billing according to feature usage.

Malicious use detection: Dynamic target information 117 associated with the way a user is utilizing application 170 may be analyzed to pinpoint exploitation of application 170 and malicious usage. For example, dynamic target information 117 may indicate an attempt to hack a password by identifying a systematic input of characters in a password entry field of application 170.

Other or different functionality may be used and applied.

Embodiments of the invention may extract dynamic target information 117, such as interesting application information (IAI), from a running application 170 to monitor application 170 without interfering with the process thereof. Embodiments of the invention may include a separate monitoring application or module 160 that may operate independently from application 170 and may extract dynamic target information 117 from application metadata 190 leaving the running application data unaffected.

Challenges overcome by embodiments of the invention may include, for example, the following.

Extracting dynamic target information 117 and the usage of such information may be a complicated task. Embodiments of the invention, utilize known states of an observed application 170, in order to extract dynamic target information 117 therefrom.

Embodiments of the invention may adapt to changes in the observed application 170 e.g., by changing the application metadata 190 or logic (e.g., page detection anchors 119) for extracting dynamic target information 117. For example, if metadata 190 initially indicates that dynamic target information 117 is to be extracted is in a specific pixel coordinate location of an application user interface or screen shot, and the coordinates of the screen are reoriented while running application 170, metadata 190 may likewise change to indicate extraction according to the new orientation of the screen. For example, metadata 190 may be re-calibrated or normalized for extracting dynamic target information 117 from an updated pixel coordinate location of a current screen shot of application user interface 195. Therefore, in order to extract dynamic target information 117, operations may be periodically updated.

Other or different challenges may be overcome using embodiments of the invention.

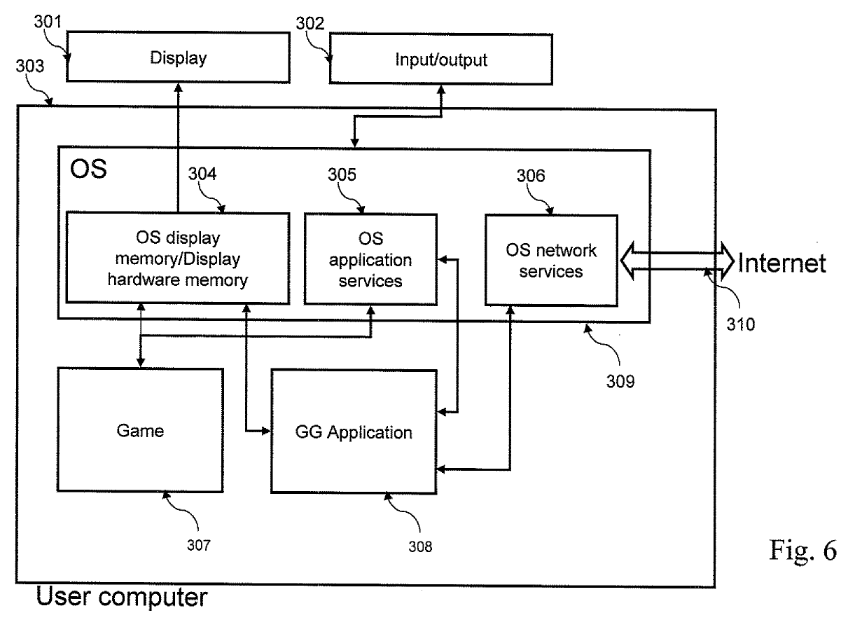

Example embodiments are further described below in connection with FIGS. 6-9. Reference is made to FIG. 6, which schematically illustrates a block diagram of a client or user side system which includes, a user computer 303, running an operation system 309, according to an example embodiment. The user computer 303 may be a client computer connected to a network, e.g., the Internet. The operating system 309 may include an operation system (OS) display memory or access to display hardware memory 304, OS application services 305 and OS network services 306. In this illustration, the operating system runs Application/Game 307 and, in parallel, the monitoring application 308 (referred to as GG Application in FIG. 6). In example embodiments, the user computer may be a personal computer running the Microsoft Windows Operating System or may be an Apple Macintosh computer, although other devices, manufacturers, and products may be used.

In an example embodiment, the game 307 may be a typical Personal Computer (PC) Game, which may be implemented using any game technology (e.g., DirectX, Open GL, flash, ActiveX, etc.) and may be developed by any publisher. The game may include any layout and design. The game may be loaded to the user computer 303, by the operating system 309 and registered as an application on the OS application services (task manager) 305. The operating system 309 may allow the game to allocate display memory 304 to generate display graphics, which are then transmitted to the display device 301.

Monitoring application 308 may monitor the OS application services, and when the game 307 is loaded, the monitoring application 308 may obtain information from the OS application services 305 about the display memory space 304 allocated to the Game application 307 for its display. The monitoring application 308 may then start to capture the game generated graphics from the OS display memory 304. Operating system routines may be called by the monitoring application 308 to obtain the game generated graphics from the OS display memory 304. In other embodiments, interrupt routines, traps or operating system patches may be used to obtain game generated graphics that are output from the Game application 307. In some example embodiments, the monitoring application 308 may have no direct connection or interfaces to the game 307. The monitoring application 308 may capture the game full screen or just specific sub-regions, e.g., shaped as rectangles, according to the provided model for the Game 307 to be monitored. The model may include metadata or code or other information for monitoring the Game 307 as described above. The models for different games and applications may be downloaded from a server computer system (described further below). In an example embodiment, based on the captured screen and specific page detection anchor, the monitoring application 308 extracts one or more image objects (e.g., shaped as rectangles or other polygons) which contain the requested graphics information, e.g., as specified by the model. The requested graphics information may include (but is not limited to): game score, highest score for a specific game session, game level, game map, time, speed, weapon used during the game, shots record, bonus points, won medals/badges, or any other graphic information the user may view during the game session. In an example embodiment, the monitoring application 308 may then compress the requested graphics information and transmit the graphics information to server 314 (e.g., described below), using the OS network services 309.

The monitoring application 308 may monitor more than one game running on the user computer 303. In addition, corresponding monitoring applications on other client computers may monitor the same or other games or applications being used by other users. In example embodiments, graphics information from games across a large number of client computers may be provided to server 314. The information obtained from the graphics information from various client computers may be provided to multiple client computers (for example, to generate a list of scores of other players of a game on other computers) or may be used to generate aggregated data or statistics that may be provided to multiple client systems (for example, an average score for all players or number of players participating in a contest that involves playing a particular game, etc.).

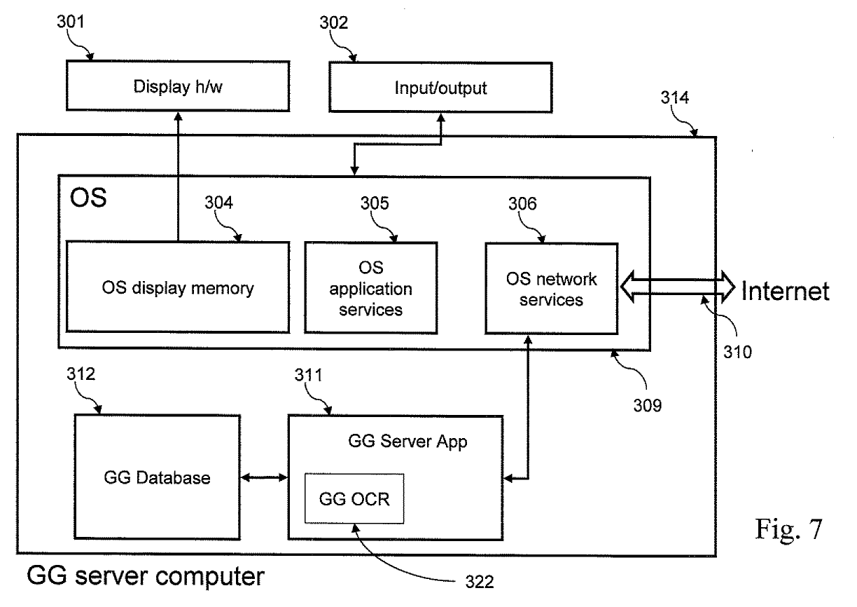

Reference is made to FIG. 7, which schematically illustrates a block diagram of a server side which includes, a server computer 314, running an operation system 309, according to an example embodiment. The operating system 309 may include OS display memory 304, OS application services 305 and OS network services 306. In this illustration, the operating system runs the server application 311 (referred to as GG Server App in FIG. 7), which includes an optical character recognition (OCR) module 322 (referred to as GG OCR in FIG. 7). The server 314 may also include a database 312 (referred to as GG Database in FIG. 7). (Although in FIG. 7 the database 312 resides on the same server, in which the server application 311 is running, it is also possible to install the database on a separate server and connect the server application 311 and the database using a network link).

In example embodiments, the database 312 may include models for various games and applications. The models may include metadata and/or code that indicate the graphics information to be extracted and sent back to the server 314. The model may include page detection anchors for extracted portions of a graphics display from OS display memory 304 in example embodiments. In other example embodiments, the model may incorporate more complex logic. In some embodiments, the model may include a state machine that tracks the flow or logic of a game or application and the graphics information to be extracted, which may vary based on the page or screen being displayed. In some example embodiments, graphics information may be extracted and processed on the server 314 by server application 322. Depending upon the information extracted from the graphics information, information may be sent back to the client computer to change the model or to change the state of the state machine for further monitoring. In example embodiments, the server application 322 may also distribute updated or additional models to client computers from time to time, including adding models for new games and applications to be monitored. In some example embodiments, a separate server, server application and/or database may be used for storing, distributing and updating models in the modeling phase from the server, server application and/or database used during monitoring of an application during the runtime phase. In other embodiments, the same server, server application and/or database may be used for both the modeling and runtime phases.

In example embodiments, the server application 311 may iteratively receive updates of “requested graphics information” from monitoring application 308 that is installed on remote user computer 303. The graphics information that is provided may be based on the model provided to the monitoring application 308 for monitoring the particular game or application. The server 311, using applicable information from the model “translates” the images into text or numerical information using the OCR module 322, saves the “translated” information in the database 312, and associates it to a user (e.g., identified by a user name or identification (ID) code) that played the particular game session.

In example embodiments, the information in the database 312 may then be processed and displayed to the user per request from the user or the monitoring application. The information in the database 312 also may be used to generate aggregated data or additional statistics that may be provided to the user or monitoring application 308. For example, data associated with multiple users may be aggregated or combined to provide a ‘high scores list’ to multiple client computers. The processed information, aggregated data or statistics may then be displayed by the monitoring application or other application on the client computer or on a separate monitoring computer. In example embodiments, monitoring information, which may be stored in the database 312 and sent to the user and/or monitoring application 308 on the client computer, may include (but is not limited to): last game score, create leader board, grant users experience points, enable competition for single player games, identify cheats, define achievements, save gaming history, which are described for example as follows.

Last game score: Even if the game application that the user played does not save the last score from a game session to another session, database 312 may record the last game score. By doing this the monitoring application 308 and server 314 may add new feature of saved scores to the game without having any interface to the game or any cooperation with the game developer.

Create leader board (based on various game statistics, such as, but not limited to, score, level, speed, shots ratio, kills/death ration etc.) between users who play the same game title, and from time to time may notify the user who is the current leader.

Grant users Experience Points (XPs) which is an appreciation or cumulative score, for their performance across one or more games regardless as to which environment these games were played (different websites/different servers) or to the fact that these game were developed/published by different entities or publishers.

Enable competition for single player games by comparing various statistics associated with multiple users playing on remote machines. For example, the statistics may be stored and compared using matrices.

Enable competition for multi-player games by comparing various metrics between multiple users (even if they don't play on the same game server) and by validating their score.

Identify and alert the use of cheats in any game. The flow of the game may be monitored and the use of a short cut, cheat or special power or configuration may be detected and stored in the database 312. The models for monitoring the particular game may include detection of graphics information that indicates that one of these methods was used. Scores obtained using one of these methods may be displayed, marked, or flagged in a listing with other scores, e.g., using a different color or font or may be annotated to indicate that one of these methods was used to obtain the score. In addition, the scores to be displayed in a leader board or score list may be selectively filtered, e.g., based upon whether one or more of these methods was used to obtain the score.

Define and grant achievements (set goals within the game that reward the user with special badges) for any game title or prize.

Save, present and publish the user's entire gaming history or a portion of the user's gaming history (e.g., over a time period or for a specific game level or game application), including, but not limited to, the user's game sessions, scores, level, maps played, time, speed, weapon used during the game, shots record, bonus points, won medals/badges, or any other graphic information the user may view during the game session, for any game title regardless as to whether the games he plays were developed/published by different entities, played on secluded environments, used different technologies or ran on various machines.

Other or different combinations of monitoring information may be stored in the database 312 and sent to the user and/or monitoring application 308 on the client computer.

In example embodiments, the above examples do not require integration with the game application 307 (to avoid collaboration with the game publisher) or any direct connection to the game application through defined interfaces of the game application. Rather, graphics information may be captured from a separate display buffer and used to generate the information described above. In other embodiments, information obtained using interfaces or files defined by the game application itself may be combined with or used to generate some or all of the information described above.

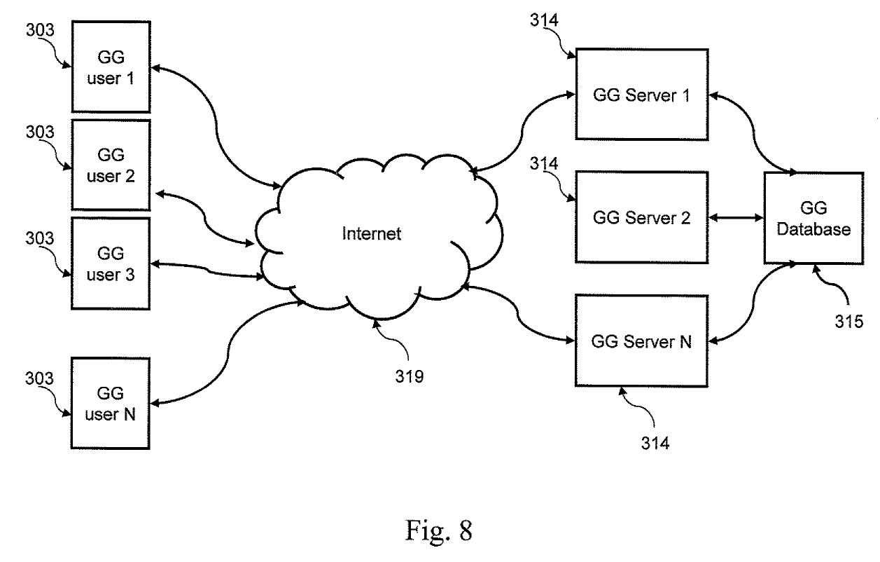

Reference is made to FIG. 8, which schematically illustrates a block diagram of multiple user computers 303 (referred to as GG users 1-4, respectively, in FIG. 8), which are connected to multiple servers 314 (referred to as GG servers 1-N, respectively, in FIG. 8), according to an example embodiment. The client computer may download a configuration file from one of the servers. The configuration file may include a list of servers that are configured to accept and process data uploaded from the client computer. The configuration parameters may be “persisted” or hardcoded in the application metadata file, e.g., by the client and refreshed periodically or iteratively, e.g., every predetermined number of seconds or minutes. When data is ready to be sent to the server, e.g., processed and queued, the client computer may attempt to upload the ready data to the first available server 314 on the list. If the network packet is rejected or unacknowledged by the server after a specified timeout the client computer may resend the packet to other servers, e.g., in order of the sequence of servers 1-N listed. The client computer may log failed attempts to send packets to the servers and may report the failed attempts to the servers. A system administrator may gather statistical data, e.g., including the failed attempt logs, in order to identify and correct problematic server configurations.

This protocol provides the required redundancy and scale to support any number of concurrent users.

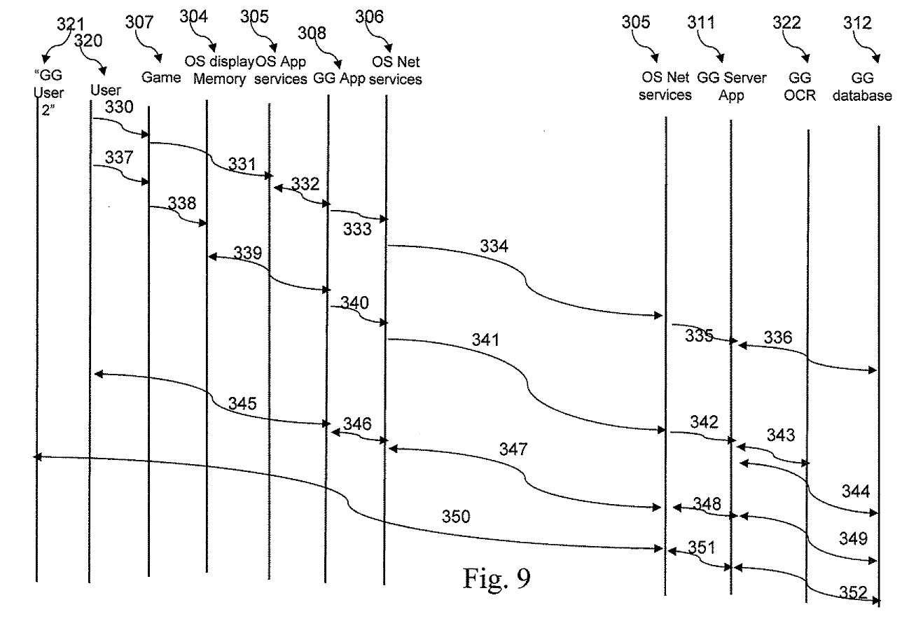

Reference is made to FIG. 9, which is a schematic flow of the interaction and information flow between a client side computing system (e.g., as described in reference to FIG. 6) and a server side computing system (e.g., as described in reference to FIG. 7), according to an example embodiment.

A user account or session 320 may start 330 a game 307 or session or level therein, which may then be registered 331 on the user computer 303 by the OS Application services 305 of the operating system 309. The client monitoring application 308 may detect the game registration by scanning 332 the OS app services module 305, mapping the game display memory space 304 and notifying the server 333 and database 312, for example, using OS net services 306, 334 using network link, 335 using OS net services 305 on the server side. The server application 311 may update 336 the database to indicate that the user session includes a new game, session, or level.

The user session 320 may include playing the game 337, and during the gameplay the game may generate graphics 338 on the display memory 304. The display memory 304 may be captured 339 by the monitoring application 308. The monitoring application may detect and crop the relevant graphics information and may then transmit the cropped graphics information 340, 341, 342 to the server application 311. The server application 311 may then translate 343 the received graphics into text or numerical information, e.g., using the OCR module 322 and may save 344 the translated text in the database 312 for further processing or for subsequent transmission to the monitoring application 308 on the client computer for display.

A user session 320, using the monitoring application 308, may access 345, 346, 347, 348 the server from a client or user computer (e.g., using the monitoring application or a browser or other applicable application) at any time to receive the game information for the user session 349, or/and cross the information with game information for other user sessions e.g., on other user computers 303.

Another user session 321 using the monitoring application 308 may access 350, 351, 352 the server from a user computer (e.g., using the monitoring application or a browser or other applicable application) at any time to receives the game information for the user session 349, and/or cross the information with game information for other user sessions e.g., 320.

Example embodiments will now be further described.

Example embodiments may include a computer implemented method for monitoring, generating and/or displaying dynamic application data, the method including any or all of the following steps:

In step (1), a model is provided from a server computer to a user computer for monitoring one or more applications that may be executed on said user computer, wherein the model may include metadata and/or code for monitoring the application. In example embodiments, the model may include information about the flow of a game and/or portions of a graphics display to be captured from the display output by the one or more applications. In example embodiments, the model may include state machine information corresponding to graphics displayed by an application for different events and different flows of operation of the application, such as the sequence of screens or pages displayed by a computer game application.

In step (2), at a user computer, it is detected when an application to be monitored has been loaded or is being executed. In example embodiments, information may be obtained from an operating system on the user computer to determine whether the application has been launched. In example embodiments, a monitoring application may also obtain information from the operating system about a display memory or portion of a display memory allocated or associated with the application to be monitored. In example embodiments, the monitoring application on the user computer may not directly interface with the application being monitored, but may obtain information output from such application from the operating system or memory.

In step (3), a message may be sent from the user computer to the server computer indicating that the application is being run. In example embodiments, the server computer may store data indicating the application is being run using a database in association with a particular user account or session associated with the user computer or a login from the user computer or from a particular monitoring application. In example embodiments, the server may store in the database information or statistics based, at least in part, on the indication that the application is being run. In example embodiments, such information or statistics may include the number of times the application has been run by the user, the dates or times that the application has been run by the user or other information.

In step (4), at the user computer, execution of the application may be monitored by capturing display data output from the application in accordance with the model. In example embodiments, specific portions of a display memory may be captured from the display memory and may be cropped, compressed or otherwise processed at the user computer. In example embodiments, processing may include determining whether the extracted display data matches criteria in the model for IAI or dynamic target information and sending the display data to the server for processing. In example embodiments, the display data may be cropped or extracted, and compressed before being sent to the server. In example embodiments, processing may include determining whether the extracted display data matches criteria of the model for changing the state or logic for monitoring (such as criteria indicating that the screen display has changed and a different portion of the display data should be captured). In example embodiments, the portion of display data that is extracted in the next iterative capture may be changed based on the current portion of display data that was extracted (and/or base on information, such as text or numerical information) obtained from such display data. Other information may also be used to change the state of monitoring, such as an elapsed time or other output from the application. In example embodiments, the capturing or extracting of display data may occur repetitively at fixed intervals or intervals specified by the model or based on interrupts or other operating system information, user control input, or application output. In example embodiments, some or all of the display data or information or statistics generated from the display data may correspond to information or statistics that the application does not typically or automatically save from one session to another session and/or information or statistics that the application does not generate at all.

In step (4), e.g., concurrently with the aforementioned user computer operations, at the server computer, extracted portions of the display data may be received from the monitoring application on the user computer. In example embodiments, the display data may be cropped or extracted and/or compressed. In example embodiments, the server may uncompress the display data and process the display data to generate information regarding the application being monitored. In example embodiments, the server system may use an extraction module, e.g., an OCR module to generate text or numerical data from the display data, such as a score for a game. The display data and/or generated information may be stored in a database in association with a user account or session. In example embodiments, the server system may accumulate information for a user in the database indicating the history of such user's use of one or more applications (such as games), including number of times played, scores, high score, times, features used to play the game during each session (such as game configuration, cheats and short cuts) and other information.

In step (5), in some example embodiments, the server application may send back to the monitoring application, browser or other application on the user computer, the information generated from the display data or instructions or parameters based on such information. In some example embodiments, such information may be automatically displayed by an application on the user computer, such as a dashboard showing all of the user's high scores. In some embodiments, information from the database for other user accounts or sessions on other user computers may also be sent to the application on the client side for display or aggregated data for multiple user accounts or sessions may be sent or statistics based on any of the foregoing may be sent. The display on the user computer may be separate from the display of the application being monitored or may be overlayed on such display (for example, by using an embedded window, pop-up or semi-transparent display of information such as scores from multiple user accounts or sessions in a corner of the game display). In addition, such information sent to the user computer may be used by the monitoring application to adjust the monitoring of the application. For example, the information from the server may be used to determine whether to change the state in a state machine model used for monitoring the application. In some example embodiments, the information generated by the server application, stored in the database and/or sent back to the client side user computer may include, for example, information or statistics that the application does not save from one session to another session and/or information or statistics that the application does not generate or display at all.

In step (6), in some example embodiments, during a user session, the user computer may access the information in the database associated with such user session and/or information regarding other users session or aggregated data or statistics for multiple user sessions. In example embodiments, the user computer may access such information through a browser. The server application may send the requested information to the browser for display on the user computer. The display on the user computer may be separate from the display of the application being monitored or may be overlaid on such display (for example, by using an embedded window, pop-up or semi-transparent display of information such as scores from multiple user sessions or accounts in a corner of the game display). This display information may be output to the same display memory as allocated to the monitored application in some embodiments.

In step (7), in some embodiments, multiple user computers may send display data for monitored applications to the server as described above. The display data from multiple user accounts or sessions may be used to generate information associated with multiple users, such as an average score or popularity or number of people playing a game (at the same time or over some period of time).

Example embodiments also include a computer system comprising at least one processor, at least one memory; and at least one program module, the program module stored in the memory and configured to be executed by the processor, wherein the at least one program module includes instructions for performing any or all of the method steps described in (1)-(7) above and/or any or all of the method steps set forth in the appended claims or otherwise described above in this application.

Example embodiments also include a computer-program product for use in conjunction with a computer system, the computer-program product comprising a computer-readable storage medium and a computer-program mechanism embedded therein, the computer-program mechanism including instructions for performing any or all of the method steps described in (1)-(7) above and/or any or all of the method steps set forth in the appended claims or otherwise described above in this application.

Example embodiments also include a computer network system comprising at least one client or user computer system and at least one server computer system, each having at least one processor, at least one memory; and at least one program module, the program module stored in the memory and configured to be executed by the processor, wherein the at least one program module in the user computer system includes instructions for performing any or all of the method steps described as being performed at a client or user computer in (1)-(7) above and wherein the at least one program module in the server computer system includes instructions for performing any or all of the method steps described as being performed at a server computer in (1)-(7) above.

Various embodiments are discussed herein, with various features. However, not all features discussed herein must be in all embodiments. Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

1. A computer implemented method for monitoring dynamic application data, the method comprising:
in a first application:
accepting a request to monitor a sub-region within a display page of a user interface of a second application;
using at least one processor to iteratively capture data from the second application during the operation thereof;
in response to determining that the captured data matches data representing the requested sub-region or page, extracting content associated with the requested sub-region from the captured data; and
displaying the extracted content.

2. The method of claim 1, comprising iteratively updating the displayed extracted content.

3. The method of claim 1, wherein determining the captured data matches data representing the requested sub-region or page comprises determining the respective metadata thereof substantially match.

4. The method of claim 1, wherein each iterative capture of data is triggered by the lapse of a predetermined time interval of the operation of the second application.

5. The method of claim 1, wherein each iterative capture of data is triggered by an event in the second application.

6. The method of claim 1, wherein the requested sub-region is drawn by a user on a display screen using a pointing device.

7. The method of claim 1, wherein iteratively capturing data comprises capturing screenshots or copying back-buffers of the user interface of the second application.

8. The method of claim 1, wherein the application includes multiple pages, and wherein content is extracted in response to determining that data was captured from the requested page.

9. A computer implemented method for monitoring dynamic application data, the method comprising:
using at least one processor to run an application having a user interface with multiple display pages;
receiving a request to monitor a sub-region within one of the display pages;
iteratively capturing data from the application user interface;
in response to determining that the captured data matches data that represents the requested one of the display pages, extracting content associated with the requested sub-region from the captured data; and
displaying the extracted content.

10. The method of claim 9, wherein each of the multiple display pages corresponds to a different scene or state of the game application.

11. The method of claim 9, wherein the data representing the requested one of the display pages is metadata from the application generated to represent the sub-region of the requested display page.

12. The method of claim 9, wherein the requested sub-region is drawn by a user on a display screen using a pointing device.

13. The method of claim 9, wherein iteratively capturing data comprises cropping a sub-region in a screen shot of the displayed application user interface.

14. A computer implemented method for generating conditions for monitoring dynamic data in an application, the method comprising:
accepting data identifying a sub-region within a display page of the application, wherein the sub-region includes the dynamic data;
accepting one or more criteria to iteratively trigger data to be captured from a user interface of the application;
using at least one processor to generate data representing the sub-region for comparing to the captured data,
generating a trigger to extract content from the captured data associated with the requested sub-region when the data representing the sub-region matches the captured data; and
storing the trigger to extract content from the captured data.

15. The method of claim 14, wherein the data representing the sub-region is metadata from the application.

16. The method of claim 14, wherein the application is a game application.

17. The method of claim 16, wherein the application includes multiple pages, and wherein content is extracted in response to determining that data was captured from the display page within which the sub-region is found.

18. The method of claim 14, wherein the requested sub-region is drawn by a user on a display screen using a pointing device.

19. The method of claim 14, wherein iteratively capturing data comprises cropping a sub-region in a screen shot of the user interface of the second application.

20. The method of claim 14, comprising storing the data identifying a sub-region, the one or more criteria to iteratively trigger data to be captured from a user interface of the application, and data representing the sub-region.

21. A system for monitoring dynamic application data, the system comprising:
a processor to operate a first application to:
accept a request to monitor a sub-region within a display page of a user interface of a second application;
iteratively capture data from the second application during the operation thereof;
in response to determining that the captured data matches data representing the
requested sub-region or page, extract content associated with the requested sub-region from the captured data; and
a display to display the extracted content.
